(19) United States
(12) Patent Application Publication
(10) Pub. No.: US 2014/0144937 A1
(43) Pub. Date: May 29, 2014

(54) Piercing Dispensing Spout

(71) Applicant: Anna Marie Arsena-Armstrong, Brecksville, OH (US)

(72) Inventor: Anna Marie Arsena-Armstrong, Brecksville, OH (US)

(21) Appl. No.: 13/684,511

(22) Filed: Nov. 24, 2012

(51) Int. Cl. B67B 7/00

(52) U.S. Cl. CPC B67B 7/26
USPC 222/81

(57) ABSTRACT

A secondary piercing dispensing spout which can be selectively inserted into a container for conducting residual materials from the punctured container. The dispensing spout can be opened or closed while remaining inserted into the container for later use.

### RELATED APPLICATION

This application claims priority from provisional application No. 61/563,674 filed Nov. 25, 2011.

### FIELD OF THE INVENTION

This invention is directed to a pouring spout, in general, and to a pouring spout which can puncture a pliable container creating a secondary opening allowing the transfer of residual material remaining in the container that the original integral spout was unable to transfer.

### BACKGROUND OF THE INVENTION

Various spouts have been proposed for use in dispensing materials from a container. These include pouring spouts which can be inserted into containers to conduct the contents thereof from the container. An example of this type of spout is the oil can spout which is inserted into the oil can by piercing the top of the can.

Other spouts include spouts which are integrally formed to the container. An example of this type of spout are the threaded spouts of a liquid laundry detergent container or the like. In addition, other spouts such as those of shampoo bottles can be attached via a threaded end.

An inherent shortcoming of most of these prior spouts and the containers with which they interact, is the residual material remaining inside the container that the spout is unable to extract. The remaining residual material is the result of a combination of factors including a poorly designed integral spout and/or in combination with a poor container design. This remaining residual material is a waste of the purchased product and is short changing the consumer who purchased the product.

In addition, the unused residual material is most often discarded with the container. Creating additional waste that must be handled by the local sanitation services and the landfills or similar waste repositories used by such services.

In the current era of a tight economy and greater focus on environmental protection, many current spouts integral to poorly designed containers leave a significant amount of residual, yet perfectly usable, material in the container. This can include, for example, laundry detergent in a plastic laundry bottle container. There is often enough residual contents remaining in such container to wash one or two more loads of laundry.

To enable extraction of such residual material, it is highly desirable to provide an improved spout adapted to puncture such a pliable container. By puncturing the container with the improved spout, a secondary opening is created through which the residual material is allowed to be transferred from the container.

### SUMMARY OF THE INVENTION

This invention is directed to a spout which is adapted to be inserted into a pliable container by piercing a sharp end of the spout through the container creating a secondary opening from the integral opening of the container. The piercing spout permits residual material to transfer from the container which was not able to be transferred from the integral spout of the container.

In the preferred embodiment, the main spout body comprises an arcuate tubular component having a pouring end at one end a sharpened piercing point at its other end. A flange extends radially from approximately the center of the spout and has a ring or gasket positioned against the piercing side of the flange. In addition, there are apertures in the spout on the piercing side of the tubular component. The spout is positioned in a container near the area mostly likely to contain the residual material. The piercing end punctures the container and the spout is inserted until the flange and ring are abutting the container to form a tight seal. The container is then positioned to allow the residual material flow into the spout apertures and exit through the pouring end of the spout.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is an exploded perspective view of an embodiment of the present invention;

FIG. 2 is an exploded perspective view of an alternative embodiment of the piercing spout of FIG. 1;

FIG. 3 is an exploded view of the piercing spout of FIG. 1 positioned in a container with residual material passing there through;

FIG. 4 is an exploded perspective view of an alternative embodiment of the piercing spout of FIG. 1;

FIG. 5 is a partial cross sectional view of the piercing spout of FIG. 1.

### DESCRIPTION OF THE PREFERRED EMBODIMENT

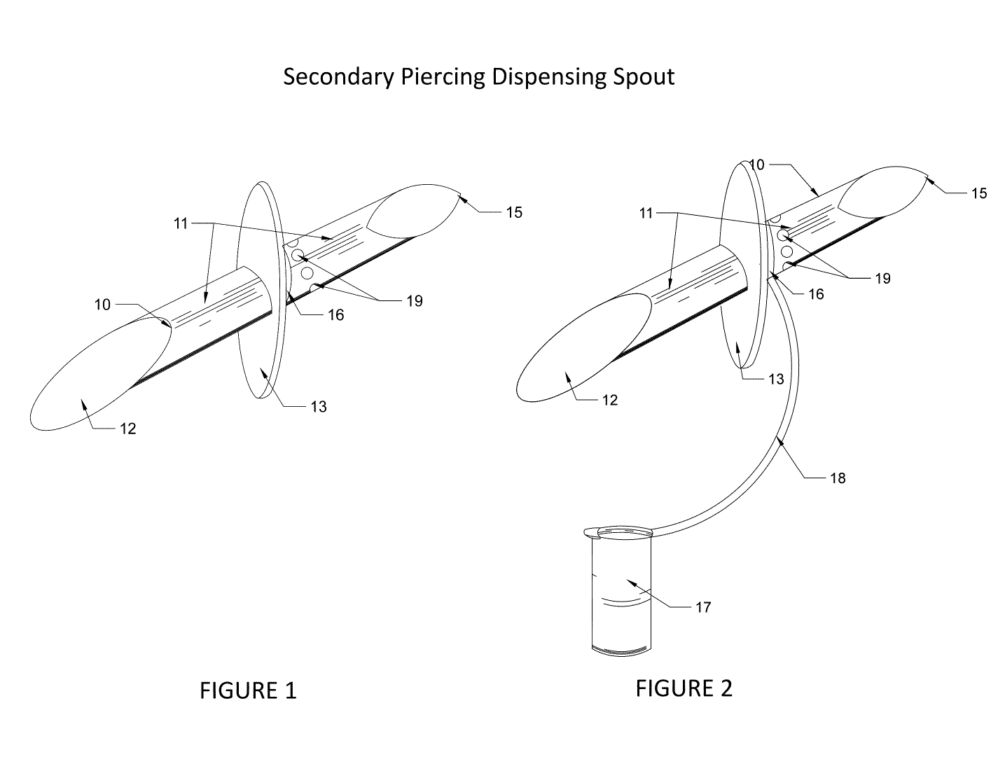

With reference now to FIGS. 1 and 2 a piercing dispensing spout 10 is shown. The dispensing spout 10 consists of a tube 11 having a pouring opening 12 at one end and a flange 13 extending radially around a middle portion of the tube 11. The dispensing spout 10 has a sharpened conical piercing point 15 at its other end. A ring or gasket 16 may be placed on the side of the flange 13 nearest the conical piercing point 15. And a cap 17 is contemplated that is attached via a thin connective line 18 connecting the cap 17 and the ring 16. There are also apertures 19 in the portion of the tube 11 on the side of the flange 13 nearest the piercing point. The dispensing spout 10 is typically machined but maybe injection molded from polymeric materials such as polypropylene or polystyrene for example, vacuum formed or manufactured by other techniques, and from other materials.

It is contemplated that the piercing dispensing spout 10 provides an improved method for obtaining the residual liquid remaining in a container. As is the case with liquid laundry detergent containers, the majority of the liquid laundry containers provide a spout for pouring the liquid from a top opening. However, the spout assembly for the majority of liquid detergent containers is flawed in that it is does not allow for all of the liquid to exit the container. This results in the consumer not getting all the detergent they purchased and a needless waste of unused detergent. There are numerous other instances of poorly constructed containers which do not provide for the dispensing of all the material in the container. Thus leaving a residual amount of material which the consumer is forced to discard.

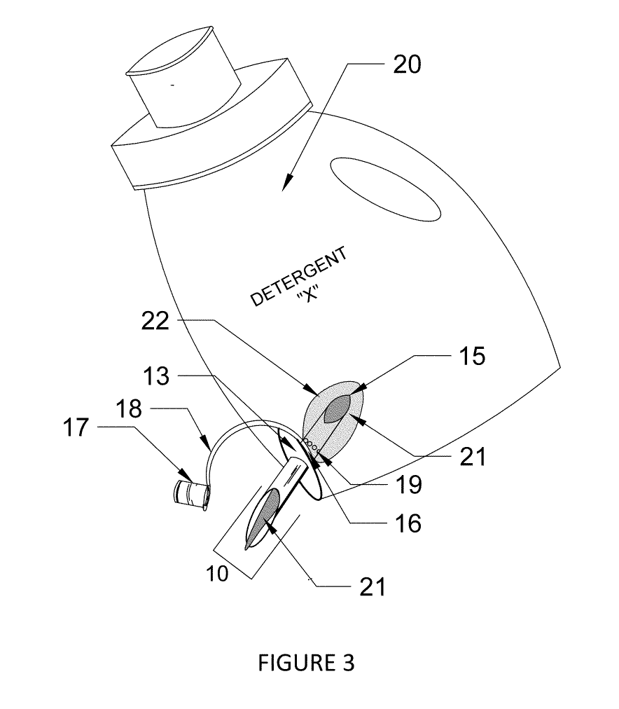

With reference to FIG. 3, a dispensing spout 10 is shown attached to a container 20. In this case, for example only, the container is a laundry detergent bottle containing a residual amount of pourable liquid 21. It is contemplated that an assorted number of containers can also be punctured should residual material remain. The spout 10 is attached to the bottle 20 by puncturing the bottle 20 with the conical piercing point 15 portion of the spout 10. The pourable contents 21 contained within the container 20 may be a liquid for example a beverage such as milk or wine or non-edible liquids such as a detergent, shampoo, etc. Alternatively the pourable contents 20 may be a solid particulate such as sugar, salt or washing powder for example.

With the dispensing spout 10 inserted into a secondary opening 22 in the container 20, the pourable contents 21 may then be poured through the spout 10 in a controlled stream. The flange 13 and ring 16 provide a tight seal around the punctured secondary opening 22. The container 20 is then tilted so as to gather the residual amount of material 21 near the secondary opening 22. The residual material 21, then flows into the apertures 19 that have now been inserted into the secondary opening 22.

Should there remain any leftover residual material 21 in the container 20, the dispensing spout 10 may be left in the container 20 and its spout opening 10 can be encapsulated by the cap 17. The container 20 may then be stored for later use. Should all residual material 21 be removed from the container 20, the dispensing spout 10 may be readily removed by pulling it out of the secondary opening 22 and stored for later use.

It is further contemplated that the dimensions of the spout may be varied so as to be compatible with a variety of differing viscosities of pourable contents. By way of non-limiting examples, these include: a. spout openings having diameters of between about 4-10 mm compatible with gels or liquids such as glue, oil-based materials or shampoo or conditioners; b. spout diameters of between 4-20 mm compatible with contents comprising materials such wine, juices, liquid detergent or solid particulates. Correspondingly, the apertures 19 may be larger or smaller depending on the viscosity of the material being emptied. The apertures may range in diameter from 0.5 mm to 5 mm.

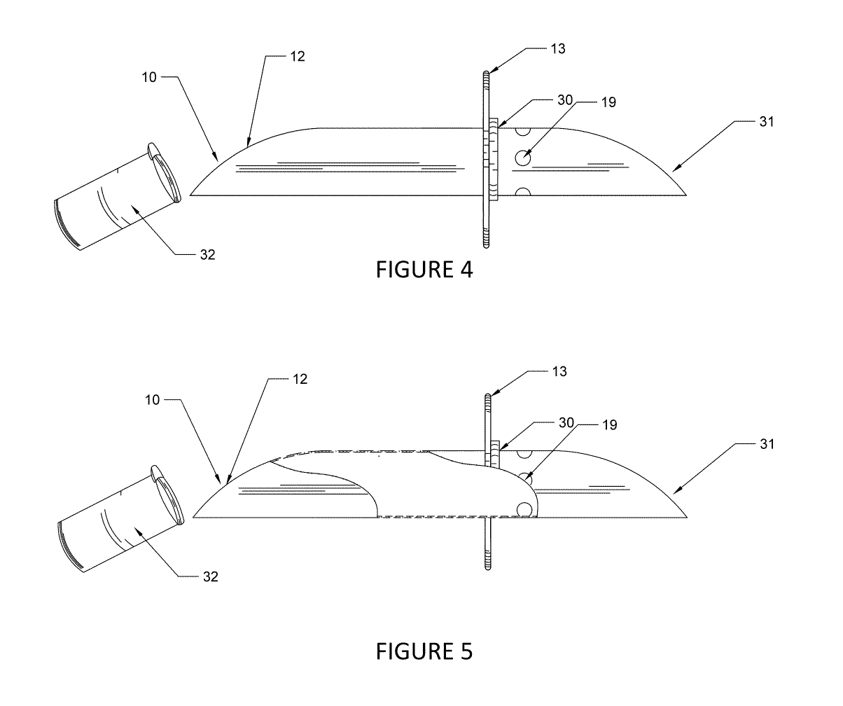

With reference to FIG. 4 a second embodiment is shown wherein the dispensing spout 10 has a washer 30 positioned on the side 31 of the flange 13 nearest the piercing point. The washer 30 is intended to prevent any seepage of the residual material as it is poured from the container. The washer 30 may also be a ring or gasket or similar type configuration which provides a seal between the flange 13 and the secondary opening. A cap lid 32 is provided, which is comprised of a diameter ensuring a tight fit over the spout 10. The cap lid 32 can be constructed from various materials including plastic, polymer, rubber or a material sufficient to provide a seal of the pouring opening 12.

Thus the scope of the present invention is described and includes both combinations and sub combinations of the various features described hereinabove as well as variations and modifications thereof, which would occur to persons skilled in the art upon reading the foregoing description.

What is claimed is:

1. A dispensing spout adapted to be releasably secured to a container or the like comprising:
a) a tubular body member having a spout with means for attachment for use with plastic containers and the like comprising a conical piercing portion and a pouring spout portion, and
b) a radially extending flange portion positioned between said conical portion and said spout portion, and
c) a sealing ring positioned around the tubular member and adjacent the radially extending flange on the piercing portion side of the flange, and
d) the tubular portion of the spout contains a plurality of apertures near the sealing ring adjacent said flange.

2. The dispensing spout of claim 1 which includes a cap to seal the spout when not in use.

3. The dispensing spout of claim 2 wherein the cap can be attached to the tubular body member.

4. The dispensing spout of claim 1 wherein the conical piercing portion includes a sharp tipped arcuate end.

5. The dispensing spout of claim 1 wherein the radially extending flange is positioned to provide a sufficient length of the tubular body member to enter the container.

6. The dispensing spout of claim 1 wherein the sealing ring forms a seal between the radially extending flange and the container wall when the tubular body member is pierced into the container.

7. The dispensing spout of claim 1 wherein the apertures intake the residual material inside the container allowing the material to enter the dispensing spout.

8. The dispensing spout of claim 1 wherein the spout portion provides means to dispense the material from the tubular body member.

9. A dispensing spout for removing the residual contents of a container comprising:
a) A tubular body member which is substantially circular in cross section,
b) A spout portion at one end of said tubular body member allowing materials to be transferred from the container,
c) A conical piercing portion located at the end of tubular body member opposite the spout portion,
d) A radially extending flange portion positioned around said tubular member, said flange positioned on said tubular member to allow a sufficient length of the tubular member to enter the container,
e) A sealing ring positioned around the tubular body member and immediately adjacent the radially extending flange on the side of the flange closest to the conical piercing portion,
f) The portion of the tubular member nearest the sealing ring contains a plurality of apertures providing means for transferring materials from outside the tubular member body into the interior of said dispensing spout.
